(19) United States
(12) Patent Application Publication
(10) Pub. No.: US 2004/0146329 A1
(43) Pub. Date: Jul. 29, 2004

(54) Printer with reverse image sheet

(75) Inventor: Gary M. Klinefelter, Eden Prairie, MN (US)

Correspondence Address: Brian D. Kaul, Westman, Champlin & Kelly, Suite 1600, 900 Second Avenue South, Minneapolis, MN, 55402-3319, US

(73) Assignee: Fargo Electronics, Inc., Eden Prairie, MN

(21) Appl. No.: 10/757,823

(22) Filed: Jan. 15, 2004

Related U.S. Application Data
(63) Continuation of application No. 09/799,196, filed on Mar. 5, 2001.

(51) Int. Cl. B41J 2/315

(52) U.S. Cl. 400/120.01

(57) ABSTRACT

A printer for identification cards as a supply of a plurality of individual intermediate transfer sheets that have a separable layer on which printing can take place. The sheets are passed across a printhead for printing images on the layer, and then an identification card from a suitable supply is positioned to overlie the printed intermediate transfer sheet. The intermediate transfer sheet and the identification card are then passed through a laminator where the layer carrying the printing is laminated to a surface of the card. The card and the laminated intermediate transfer sheet are then passed through a separator that will peel away a backing sheet for the layer carrying the printing, and the printed image will remain in place on the card.

### BACKGROUND OF THE INVENTION

The present invention relates to an identification card printer that utilizes sheets of material having a separable layer on which an image can be printed, with the image receiving layer on the sheet laminated to the card surface, leaving the printed image on the card, after which a film carrying the image receiving layer is peeled away.

Use of film that has an image receiving layer which are wound onto rolls is known. Both the 3M Company of St. Paul, Minn., and Dai Nippon Printing of Japan, have developed intermediate layer transfer films wherein there is a reverse image that is printed onto a layer that is carried on a protective film. U.S. patent application Ser. No. 09/310,077 filed May 10, 1999, illustrates a type of printer that utilizes an intermediate transfer film on which sublimation printing takes place and wherein the intermediate transfer film has to be reversed in direction during the printing operation for accomplishing the desired multi-colored printing.

### SUMMARY OF THE INVENTION

The present invention relates to the provision of a card printer using reverse image sheets that have an intermediate layer that can be laminated onto the card. The sheets are individually cut to a size that is slightly larger than the identification card used, and comprise a film or backing of a polyester material, and an image receiving layer on the polyester backing film. The image receiving layer is a polymer sheet that has an exposed image receiving surface on which printing can take place and which can be separated from the backing film.

The reverse image intermediate transfer sheets are cut to a size which has a slightly larger perimeter than the identification card on which they are to be placed. One benefit from using intermediate transfer sheets that are larger than the card is that the print are a can be oversize and transferred so the printing is out to the edges of the card. The projection from the card edges makes separation or peeling of the backing film from the print carrying or image receiving intermediate layer possible after the intermediate layer has been laminated onto a card. The edge of the intermediate transfer sheet that sticks out beyond the side edges of the card, in particular, provides a place for a sled type guide to engage the backing sheet and peel it away from the then laminated image intermediate layer and identification card.

The image receiving or intermediate layer is made of a clear, scratch resistant polymer that has an ink receptive surface that is exposed for printing. The ink receptive surface can be made in any desired manner, but is porous enough to absorb ink or accept dye sublimation printing, so that the ink adheres in place and make a permanent image.

The printing on the image receiving layer is a mirror image of the printing or graphics display which is to be read, because the printed side is laminated to the card surface. The printing would be read through the clear polymer forming the image receiving layer. The polymer that is used for the image receiving layer that separates from the backing film of the reverse image sheets, is heat sensitive for adhering to the card after lamination, and will present a shiny surface when the polyester backing film has been peeled away from the identification (ID) card after lamination. The intermediate layer sheets are flexible, but are self supporting when held by an edge, so they remain fairly flat for handling. Because the ID cards are more rigid than the intermediate transfer sheets, the cards can be directed along paths that are different from the path of the intermediate transfer sheets. The intermediate transfer sheets are flexible but are supportable on rollers without excessive deflection.

The printing formed will be against the ID card surface so that it will be protected from ambient conditions. The polymer forming the image receiving layer, that remains on the card after the backing film is peeled away, and protects the printing and includes features such as scratch resistance and UV light blocking.

The apparatus includes a source of an intermediate transfer sheet that carries a separate image receiving layer which is printed with an image, identification data or a message, and a source of identification cards. The intermediate transfer sheet is moved past a printhead, to receive a printed image on the image receiving layer, and then a laminator laminates the intermediate transfer sheet to an identification card. The intermediate transfer sheet generally includes a print receptive layer that is backed with a film. The film is separated from the print receptive layer after lamination. Use of individual intermediate transfer sheets makes handling the printing and lamination onto individual cards easier than previous forms of transfer.

Although the image receiving sheets used may be different for different types of printing, the same method can be used for both jetted inks or thermally transferred dye ribbons.

### BRIEF DESCRIPTION OF THE DRAWINGS

FIG. 1 is a schematic representation of the apparatus used for the present invention;

FIG. 2 is a schematic perspective view of lamination rolls and a sheet separator to separate the card from a film carrying the transfer layer;

FIG. 3 is a plan view of an identification card showing an intermediate transfer sheet below the card;

FIG. 4 is a vertical sectional view through the card and intermediate transfer sheet taken generally on line 4-4 of FIG. 3;

FIG. 5 is an enlarged sectional view of the intermediate transfer sheet used with the present invention; and

FIG. 6 is a schematic view of a dye sublimation printhead with supply and takeup rollers for a print ribbon.

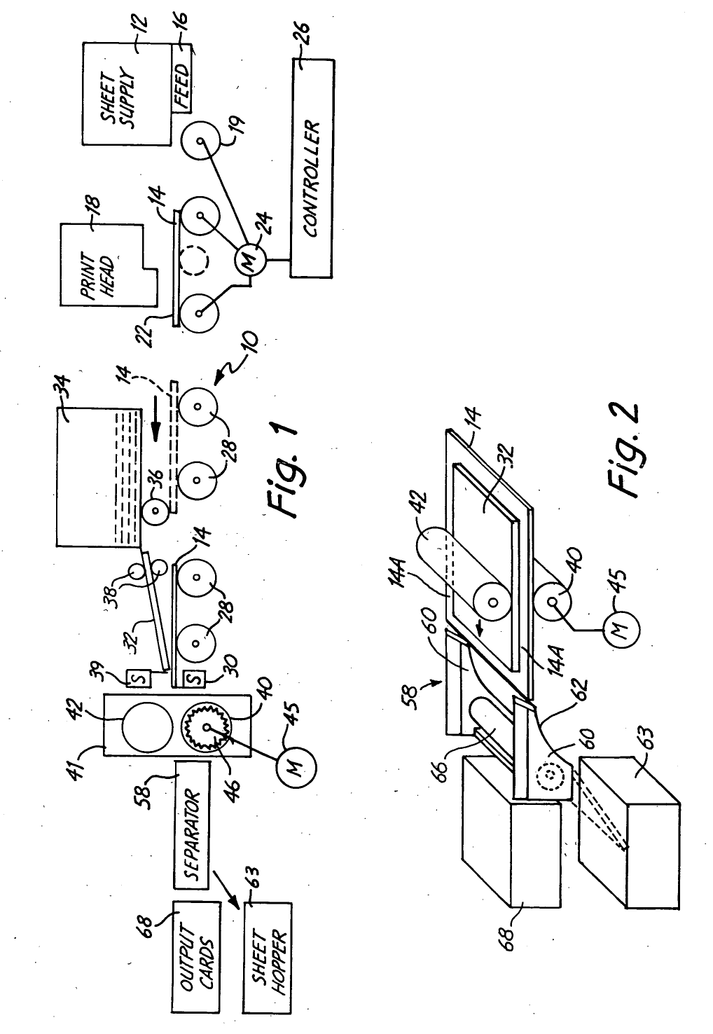

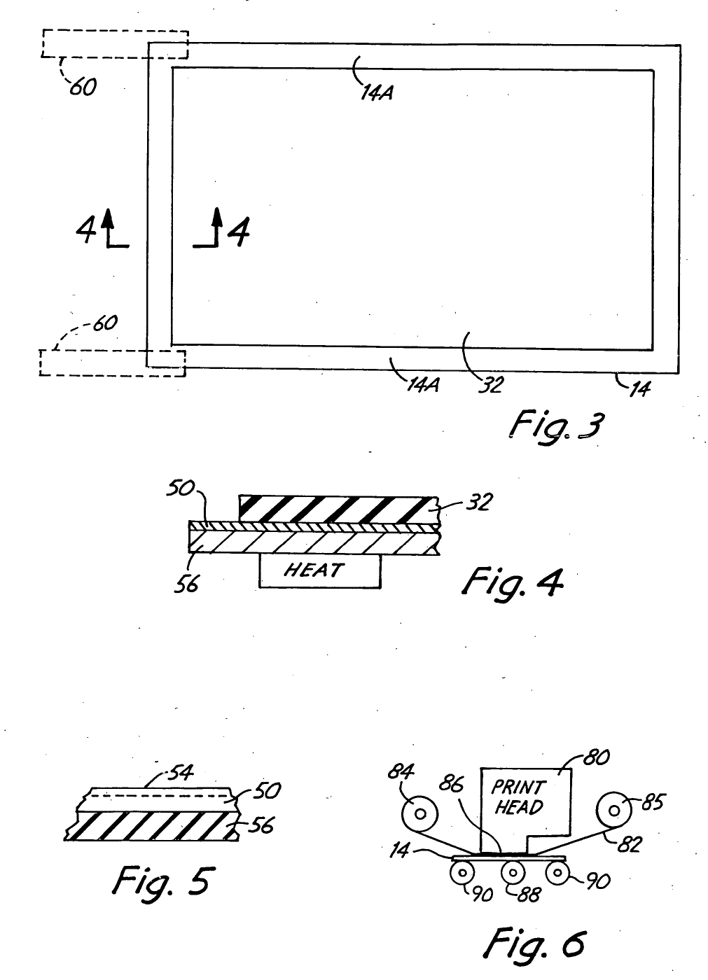

### DETAILED DESCRIPTION OF THE PREFERRED EMBODIMENTS

In FIG. 1, an identification card printer and laminator indicated generally at 10 includes a hopper or cartridge 12 that supplies a plurality of individual intermediate transfer sheets shown generally at 14. A sheet feeder 16, of and desired known type will be used for removing individual intermediate transfer sheets 14, one at a time, and transfer rollers 19 can move the sheets to a position underneath a printhead 18. The printhead can be an inkjet printhead or a dye sublimation printhead, or other forms of printer.

The intermediate transfer sheets 14 will be supported on transfer rollers 20A and 20B at the printhead 18, and other additional rollers as needed for supporting the sheets adequately while the printhead 18 operates to print an image on the upper surface 22 of each sheet individually.

The sheet feeder 16, roller 19, as well as the rollers 20A and 20B can be driven with suitable motors such as motor 24 under control of a central controller 26.

The central controller 26 will include a program to sequence the operations, and also will act to energize the printhead 18 at appropriate times under a program to print the desired images onto the surface 22 of the individual intermediate transfer sheet 14 beneath the printhead 18. In some instances the intermediate transfer sheets may need a support surface or roller directly under the printhead, as shown in dotted lines in FIG. 1 and in FIG. 6.

When the printing on the ink receptive transfer layer of the intermediate transfer sheet 14 is completed, the intermediate transfer sheet 14 is transferred to suitable driven transfer rollers indicated generally at 28, and can be supported on other suitable guides or supports. The intermediate transfer sheet is moved to a reference position, where it is sensed by a sensor 30.

A plurality of identification cards 32 are stored in a ca-rd storage hopper 34. The card hopper 34 can be located as desired adjacent the path of movement of the intermediate transfer sheets. The identification cards 32 need to be individually moved into registry with a printed intermediate transfer sheet.

A card feeder or feed roller 36 is provided on the lower side of the hopper 34, and is shown schematically since card feeders are well known. The card feeder 36 guides a card 32 to transfer rollers 38 and to a position where the card leading edge is sensed by a sensor 39. The sensor 39 indicates that the card 32 is at a proper indexed position relative to the intermediate transfer sheet sensed by the sensor 30. The sensors 30 and 39 may be optical sensors, and will provide signals to controller 26, which then starts the drive that simultaneously drives both the intermediate transfer sheet 14 and the indexed ID card 32 to a lamination station 41.

The lamination station 41 includes a heated roller 40 and a guide or pressure roller 42 used for lamination. The card 34 is kept in its indexed position overlying or in registry with the intermediate transfer sheet 14. The heated lamination roller 40 and the guide or pressure roller 42 hold the intermediate transfer sheet and the card in contact, and pressed together and then the laminating roller 40 will be driven with a motor 45 and heated with a suitable heater 46. This will cause a heat lamination of an image receiving layer on the intermediate transfer sheet 14 onto the card.

In the preferred form of the invention, which is shown in FIGS. 4 and 5, for example, the intermediate transfer sheet 14 has a polyester backing film 56 that carries a clear polymer image receiving transfer layer 50. The image receiving layer 50 is a polymer that has an ink receptive surface portion 54 on its upper face 22, which faces the card 32.

The lamination between the polymer layer 50 and the card 32 is accomplished by applying heat from the roller 40 and the heater 46 a sufficient length of time to cause lamination. The mating surfaces stick together through application of heat and pressure. The backing film 56 is joined to the image receiving layer 50 by adhesion, but when the heat of lamination occurs, the polymer image receiving layer 50 and the ink receptive surface portion 54 will adhere to the card 32, and thus transfer to the card 32. The backing film 56 can be stripped away or peeled away from the card and the portion of the image receiving layer that has been laminated in place.

After lamination, a separator 58 is used to separate the backing film 56 from the image receiving transfer layer 50, which is adhering to the card 32. A set of plows or sliders 60 which run along the side edge portions 14A of the intermediate transfer sheets, as the card 32 and laminated intermediate transfer sheet exit the lamination station 41. The plows 60 have curved or inclined surfaces 62 that move the side edge 14A downwardly, away from the card 32, and the image receiving transfer layer 50 in the area laminated to the card remains laminated and the edge portion 14A and the entire backing film peel off the card, and slide down to a used sheet receptacle 63. The layer 50 will separate at the edges of the card quite easily.

The laminated card 32, which is relatively rigid, can be guided across a guide roller 66, and deposited in a finished card hopper 68 as desired.

The use of individual sheets simplifies the operations so that printing can be customized, and then the image receiving transfer layer is separated from the backing film at a suitable time. The lamination takes place when the backing film 56 is still in place, to laminate the print receptive layer 50 and the printing onto the card 32 using a heated roller or other heat source.

Once the lamination occurs, the backing film 56 can be separated from the polymer material that forms the receptive layer easily. The exposed surface of this layer will be heated so that it will provide a shiny, scratch-resistance surface on the card that carries the printing. The larger size intermediate transfer sheets permit printing in a print area that is larger than that which can be printed directly on a card, and thus the printing transferred to the card can be from edge to edge on the card.

An important feature of this printer is that the ink jet form is that all of the media can be in an easy to use cartridge.

FIG. 6 is a schematic representation of a typical printing arrangement utilizing dye sublimation printing. A dye sublimation printhead 80 is provided, and is used for printing from a print ribbon 82 onto an intermediate transfer sheet 14. This transfer sheet 14 is shown supported on suitable rollers or supports including a platen 88, and support and drive rollers 90. The ribbon 82 is provided from a supply roll 84 and passes under a printhead portion 86 that has heaters for transferring material from the ribbon 82 to the upper surface of the intermediate transfer sheet 14. The ribbon 82 is stored on a takeup roll 85 in the normal manner.

The schematic showing of a printhead in FIG. 6 can be used in the same printer and laminator system as that shown in FIG. 1, but would include the supply and takeup rolls for the dye sublimation ribbon.

While identification cards shave been used in this description, other cards can be handled and printed in the same way, including, but not limited to, financial, debit, credit and phone cards. The term card is meant to include such cards that are capable of being laminated with a reverse image printed layer.

Although the present invention has been described with reference to preferred embodiments, workers skilled in the art will recognize that changes may be made in form and detail without departing from the spirit and scope of the invention.

What is claimed is:

1. A card printer comprising:
a source of at least one intermediate transfer sheet;
a source of at least one card;
a printhead configured to print onto the intermediate transfer sheet;
a sheet transport configured to move intermediate transfer sheet past the printhead; and
a laminator configured to apply pressure to the card when aligned with the intermediate sheet.

2. The card printer of claim 1 wherein said intermediate transfer sheet is cut to a size providing sheet extensions from at least one side of the card.

3. The card printer of claim 1 wherein said source of one intermediate transfer sheet comprises a plurality of intermediate transfer sheets, and a sheet feeder for feeding individual sheets to the printhead.

4. The card printer of claim 3 wherein the source of at least one card comprises a stack of cards, a card feeder, said card feeder feeding at least one card to overlie the at least one intermediate transfer sheet prior to the laminator operating to apply pressure to the card and the intermediate transfer sheet.

5. The card printer of claim 4 wherein said laminator comprises a heater for providing lamination heat to the intermediate transfer sheet and card.

6. The card printer of claim 1 wherein said intermediate transfer sheet comprises a printable layer on a film, said printable layer adhering to the card when the laminator has applied heat and pressure to the card, and a guide for separating the film from the card and laminated printable layer after lamination.

7. The card printer of claim 1 comprising a supply of individual sheets corresponding to a desired size relating to a size of the card, each of the sheets having an image receiving layer thereon that is print receptive, a printhead positioned to print onto the image receiving layer of one of the intermediate transfer sheets sequentially presented to the printhead, a sheet transport configured to move the intermediate transfer sheet past the printhead, a laminator comprising a heated roll for receiving the sheet after printing, and for receiving an card in contact with the image receiving layer, after printing, the laminator being operable to laminate the image receiving layer to a surface of the card, and a device for peeling a backing film the print receptive layer subsequent to lamination.

8. A printer for cards, including identification and credit cards, the printer including a printhead, a supply of individual intermediate transfer sheets, each intermediate transfer sheet including a backing film and a separable print receptive layer carried by the backing film, a sheet drive for moving an individual intermediate transfer sheet from the supply to the printhead for printing on the separable layer of the intermediate transfer sheet, a supply of cards, a drive for the cards and the individual intermediate transfer sheets to move the cards to a position to overlie the image receiving layer on the intermediate transfer sheet, a laminator for applying heat and pressure to the card and intermediate transfer sheet with which it is aligned, and a separator for separating the backing film from the image receiving layer laminated to the card.

9. The card printer of claim 8, wherein the separator includes a ramp surface for engaging a portion of the intermediate transfer sheet extending from an Edge of the card after lamination, for guiding the intermediate transfer sheet away from the path of the card and separating the backing film from the image receiving layer laminated on the card.

10. The card printer of claim 8, wherein said printhead comprises an inkjet printhead.

11. The card printer of claim 8, wherein said printhead comprises a dye sublimation printhead, and a supply of dye sublimation ribbon for said dye sublimation printhead.

12. The card printer of claim 8, wherein said intermediate transfer sheet is larger than said card, whereby the printing extends from edge to edge of the card after intermediate transfer sheet and card have been operated on by the laminator.

13. A method of applying an image carrying polymer layer to a card comprising providing a supply of intermediate transfer sheets configured to overlie a card, printing on a surface of a layer on the intermediate transfer sheet, providing a card to overlie the layer on which the printing has taken place, passing the card and the intermediate transfer sheet through a laminator to laminate a portion of the layer to the card, and separating a backing film from the layer to leave the portion of the layer laminated to the card adhering to the card.

14. The method of claim 13, including printing reverse images on the layer.

15. The method of claim 13, including providing sensors for sensing when the card and intermediate transfer sheet are in registry, prior to laminating the layer to the card.

16. The method of claim 13, including providing a supply of a plurality of cards, and a card feeder to move an individual card to a position to overlie the intermediate transfer sheet after printing, and to be indexed to the intermediate transfer sheet for lamination.
